(19) United States
(12) Patent Application Publication
(10) Pub. No.: US 2020/0089031 A1
(43) Pub. Date: Mar. 19, 2020

(54) METHOD OF PRODUCING LIQUID CRYSTAL PANEL

(71) Applicant: Sharp Kabushiki Kaisha, Sakai City (JP)

(72) Inventor: Shinichi HIRATO, Sakai City (JP)

(21) Appl. No.: 16/562,489

(22) Filed: Sep. 6, 2019

Related U.S. Application Data
(60) Provisional application No. 62/733,247, filed on Sep. 19, 2018.

(51) Int. Cl. G02F 1/1347; G02F 1/1339; G02F 1/13

(52) U.S. Cl. CPC G02F 1/1347; G02F 2001/133565; G02F 1/1303; G02F 1/13394

(57) ABSTRACT

A method of producing a liquid crystal panel includes an abutment area determination step for determining, within a range sandwiched between an approximate curve obtained by plotting, when a difference between a protrusion height of a spacer formed to protrude from one substrate to the other substrate and a distance between the substrates is used as a reference value, an upper-limit value of a substantial abutment area per unit area of the one substrate on the other substrate for each of a plurality of plate thicknesses of the pair of substrates that differ from one another and a straight line on which the abutment area is set to 230 μm²/mm² regardless of the plate thickness, the abutment area depending on the plate thickness, a spacer formation step for forming the spacer to have the abutment area determined in the abutment area determination step, and a bonding step for bonding the pair of substrates to each other.

### CROSS REFERENCE TO RELATED APPLICATION

This application claims priority from U.S. provisional patent application No. 62/733,247 filed on Sep. 19, 2018. The entire contents of the priority application are incorporated herein by reference.

### TECHNICAL FIELD

The present invention relates to a method of producing a liquid crystal panel.

### BACKGROUND

An example of a conventionally known method of producing a liquid crystal panel is one described in Japanese Patent Application No. 5980104 The method of producing a liquid crystal panel described in Japanese Patent Application No. 5980104 includes a step of forming a columnar spacer on a main surface of a CF substrate and then measuring the height of the columnar spacer, a step of bonding a TFT substrate and the CF substrate to each other and then measuring a gap between the TFT substrate and the CF substrate, and a step of judging whether or not the liquid crystal panel is good based on a difference between the measured height of the columnar spacer and the measured gap.

In recent years, a liquid crystal panel may have been required to be thinned. In the case, a glass substrate constituting the produced liquid crystal panel has been subjected to slimming processing. Accordingly, diversity tends to increase with respect to the plate thickness of the glass substrate constituting the liquid crystal panel. However, the above-described Japanese Patent Application No. 5980104 does not consider the plate thickness of the glass substrate. When the number of columnar spaces to be installed, for example, is made constant regardless of the plate thickness of the glass substrate being diversified, there have been problems. For example, a liquid crystal material is accumulated on the lower end side of the produced liquid crystal panel by gravity when the liquid crystal panel is leaned so that a display failure occurs.

### SUMMARY

The present invention has been completed based on the above-described circumstances, and is directed to making it difficult for a display failure to occur even if the plate thickness of a substrate is diverse.

(1) An aspect of the present invention is a method of producing a liquid crystal panel, the method including an abutment area determination step for determining, within a range sandwiched between an approximate curve obtained by plotting, when a difference between a height of a spacer that is interposed between a pair of substrates with a liquid crystal layer sandwiched therebetween and holds a distance between the pair of substrates by abutting on its counterpart and the distance is set as a reference value, an upper-limit value of a substantial abutment area per unit area on the counterpart for each of a plurality of plate thicknesses of the pair of substrates that differ from one another and a straight line on which the abutment area is set to 230 μm²/mm² regardless of the plate thickness, the abutment area depending on the plate thickness, a spacer formation step for forming the spacer to have the abutment area determined in the abutment area determination step, and a bonding step for bonding the pair of substrates to each other.

(2) The aspect of the present invention is the method of producing the liquid crystal panel in which in the abutment area determination step, a minimum value and a maximum value related to the difference are found, and a range between the minimum value and the maximum value is set as the reference value in addition to the configuration in the above-described item (1).

(3) The aspect of the present invention is the method of producing the liquid crystal panel, in which in the abutment area determination step, the reference value is set in a range from 0.13 μm to 0.17 μm in addition to the configuration in the above-described item (2).

(4) The aspect of the present invention is the method of producing the liquid crystal panel, in which in the abutment area determination step, the reference value is set to 0.15 μm in the configuration in the above-described item (3).

(5) The aspect of the present invention is the method of producing the liquid crystal panel, in which in the abutment area determination step, the abutment area is determined depending on the plate thickness within a range sandwiched between the approximate curve and a straight line on which the abutment area is set to 234 μm²/mm² regardless of the plate thickness in addition the configuration in any one of the above-described items (1) to (4).

(6) The aspect of the present invention is the method of producing the liquid crystal panel, in which in the abutment area determination step, the abutment area is determined depending on the plate thickness within a range sandwiched between the approximate curve and a straight line on which the abutment area is set to 240 μm²/mm regardless of the plate thickness in addition to the configuration in the above-described item (5).

(7) The aspect of the present invention is the method of producing the liquid crystal panel, in which in the abutment area determination step, the approximate curve is set in a strip shape having a width of ±20 μm²/mm² in addition to the configuration in any one of the above-described items (1) to (6).

(8) The aspect of the present invention is the method of producing the liquid crystal panel, in which in the abutment area determination step, the approximate curve includes a plurality of approximate curves prepared for each of a plurality of maximum environmental temperatures assumed in a use environment of the liquid crystal panel, and the abutment area is determined depending on the maximum environmental temperature in addition to the plate thickness within a range sandwiched between the one approximate curve selected from among the plurality of approximate curves and the straight line in addition to the configuration in any one of the above-described items (1) to (7).

(9) The aspect of the present invention is the method of producing the liquid crystal panel, further including a slimming step for polishing a plate surface opposite to a plate surface on the side of the liquid crystal layer in the pair of substrates to slim the pair of substrates in addition to the configuration in any one of the above-described items (1) to (8).

(10) The aspect of the present invention is the method of producing the liquid crystal panel, in which the spacer is selectively formed on one of the pair of substrates in the spacer formation step, and the spacer is made to abut on the other substrate when the paired substrates are bonded to each other in the bonding step in addition to the configuration described in any one of the above-described items (1) to (9).

(11) The aspect of the present invention is the method of producing the liquid crystal panel, in which a first spacer constituent section constituting the spacer is formed on one of the pair of substrates while a second spacer constituent section constituting the spacer is formed on the other substrate in the spacer formation step, and the first spacer constituent section and the second spacer constituent section are made to abut on each other when the paired substrates are bonded to each other in the bonding step in addition to the configuration described in any one of the above-described items (1) to (9).

According to the present invention, it can be made difficult for a display failure to occur even if the plate thickness of a substrate is diverse.

### BRIEF DESCRIPTION OF THE DRAWINGS

FIG. 1 is a schematic sectional view of a liquid crystal panel according to a first embodiment of the present invention.

FIG. 2A is a cross-sectional view illustrating a CF substrate in a state where a seal formation process included in a method of producing the liquid crystal panel has been performed.

FIG. 2B is a cross-sectional view illustrating a CF substrate in a state where a liquid crystal dropping process included in the method of producing the liquid crystal panel has been performed.

FIG. 2C is a cross-sectional view illustrating a CF substrate and an array substrate in a state where a bonding process included in the method of producing the liquid crystal panel has not been performed yet.

FIG. 2D is a cross-sectional view illustrating a liquid crystal panel in a state where a slimming process included in the method of producing the liquid crystal panel has been performed.

FIG. 3 is a cross-sectional view of a liquid crystal panel in which the plate thickness of a pair of substrates is small.

FIG. 4 is a cross-sectional view of a liquid crystal panel in which the plate thickness of a pair of substrates is large.

FIG. 5 is a graph illustrating an experimental result in a case where the plate thickness of a pair of substrates is 0.15 mm in a comparison experiment 1.

FIG. 6 is a graph illustrating an experimental result in a case where the plate thickness of a pair of substrates is 0.5 mm in the comparison experiment 1.

FIG. 7 is a graph illustrating an experimental result in a comparative experiment 2.

FIG. 8 is a graph illustrating an experimental result in a comparative experiment 3.

FIG. 9 is a table illustrating an experimental result in a comparative experiment 4.

FIG. 10 is a graph illustrating the experimental result in the comparative experiment 4.

FIG. 11 is a graph illustrating an experimental result in a comparative experiment 5 according to a second embodiment of the present invention.

FIG. 12 is a graph illustrating an experimental result in a comparative experiment 6.

FIG. 13 is a graph illustrating an experimental result in a comparative experiment 7.

FIG. 14 is a graph illustrating an experimental result in a comparative experiment 8.

FIG. 15A is a cross-sectional view illustrating a CF substrate and an array substrate in a state where a spacer formation process and a seal formation process included in a method of producing a liquid crystal panel according to a third embodiment of the present invention have been performed.

FIG. 15B is a cross-sectional view illustrating a CF substrate and an array substrate in a state where a bonding process included in the method of producing the liquid crystal panel has not been performed yet.

FIG. 15C is a cross-sectional view illustrating a liquid crystal panel in a state where a slimming process included in the method of producing the liquid crystal panel has been performed.

### DESCRIPTION

### First Embodiment

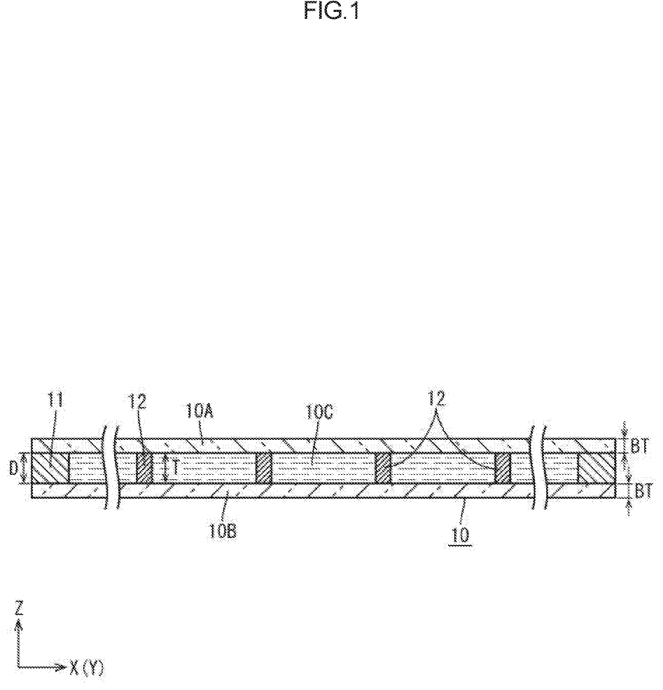

A first embodiment of the present invention will be described with reference to FIG. 1 to FIG. 10. In the present embodiment, a method of producing a liquid crystal panel 10 will be illustrated as an example. The liquid crystal panel displays an image using light from a backlight device (lighting device) not illustrated. An X-axis, a Y-axis, and a Z-axis are illustrated in a part of each of the drawings, and a direction along each of the axes is drawn to be a direction illustrated in each of the drawings. An upper side and a lower side in FIG. 1, for example, are respectively a front side and a rear side.

FIG. 1 is a schematic sectional view of the liquid crystal panel 10. The liquid crystal panel 10 includes at least a pair of substrates 10A and 10B and a liquid crystal layer 10C sandwiched between the pair of substrates 10A and 10B, as illustrated in FIG. 1. Each of the pair of substrates 10A and 10B is formed by stacking various types of films on the inner surface side of a transparent glass substrate. Out of the pair of substrates 10A and 10B, the substrate on the front side (front surface side) is set as a CF substrate (the one substrate, an opposite substrate) 10A, and the substrate on the rear side (back surface side) is set as an array substrate (the other substrate, an active matrix substrate, a TFT substrate) 10B. A structure such as an orientation film is provided in addition to a color filter having respective colored portions in R (red), G (green), B (blue), and the like arranged in a predetermined array and a light shielding portion (black matrix) that separates the adjacent colored portions being provided, illustrations of which are both omitted. The array substrate 10B is provided with a switching element (e.g., a TFT) connected to a source line and a gate line which are perpendicular to each other and structures such as a pixel electrode and an orientation film connected to the switching element, illustrations of which are both omitted. The liquid crystal layer 10C is composed of a liquid crystal material including liquid crystal molecules as a substance that changes in optical characteristic as an electric field is applied thereto. The liquid crystal panel 10 has a rectangular shape, and its long side direction, its short side direction, and its thickness direction (a normal direction of its plate surface) respectively match an X-axis direction, a Y-axis direction, and a Z-direction in each of the drawings, for example.

The liquid crystal panel 10 is provided with a seal section 11 interposed between respective outer peripheral ends of the pair of substrates 10A and 10B in a form surrounding the liquid crystal layer 10C and a spacer 12 disposed nearer to the center than the seal section 11 and interposed between respective central portions of the pair of substrates 10A and 10B. The seal section 11 is composed of a ultraviolet curable resin material or a thermosetting resin material, for example, and has a frame shape to seal the liquid crystal layer 10C sandwiched between the pair of substrates 10A and 10B. The spacer 12 is provided on the CF substrate 10A out of the pair of substrates 10A and 10B. The spacer 12 is formed in a substantially columnar shape protruding toward the array substrate 10B while penetrating the liquid crystal layer 10C from the CF substrate 10A, and holds a distance D between the pair of substrates 10A and 10B, i.e., a thickness (a cell gap) of the liquid crystal layer 10C by its protruding distal end surface abutting on an inner surface of the array substrate 10B. The thickness of the liquid crystal layer 10C held by the spacer 12 is preferably approximately 2 μm to 5 μm, but not necessarily limited to this. The spacer 12 is composed of a resin material having a light transmission property, for example, and is formed within a plate surface of the CF substrate 10A by a known photolithography method, like another structure, when the CF substrate 10A is produced. The spacer 12 easily disturbs an orientation of a liquid crystal material in the vicinity of itself, although it has alight transmission property. Accordingly, the spacer 12 is preferably disposed to overlap the light shielding portion and a wiring (a light shielding structure) on the side of the array substrate 10B, but not necessarily limited to this. The spacer 12 is preferably regularly arranged within the plate surface of the CF substrate 10A, but not necessarily limited to this.

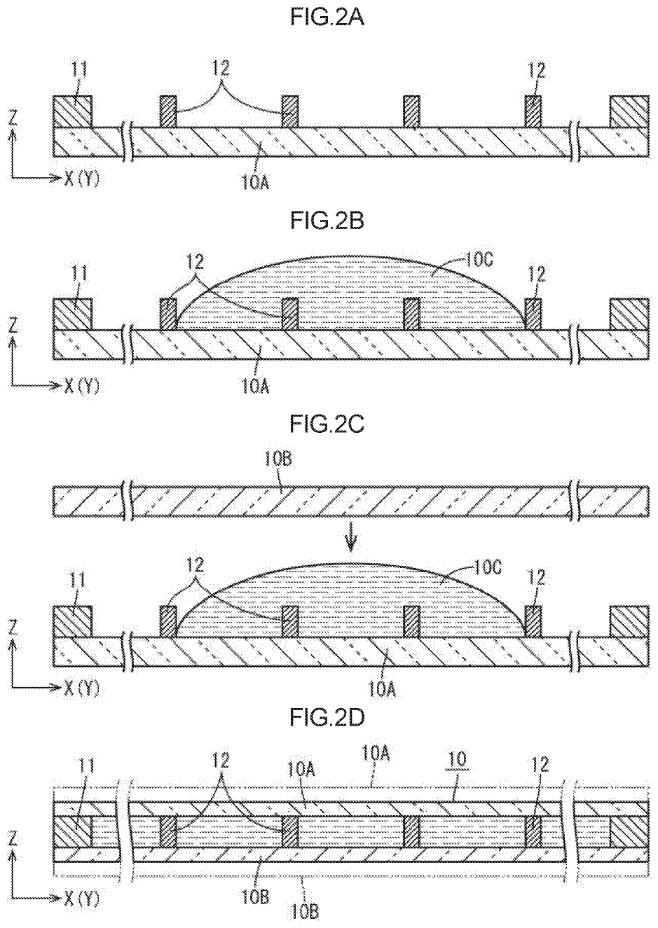

The liquid crystal panel 10 is configured as described above. Then, an outline of a method of producing the liquid crystal panel 10 will be described with reference to FIG. 2A to FIG. 2D. The method of producing the liquid crystal panel 10 includes at least a CF substrate production process for producing the CF substrate 10A, an array substrate production process for producing the array substrate 10B, a seal section forming process for forming the seal section 11 on the CF substrate 10A, a liquid crystal dropping process for dropping a liquid crystal material on the CF substrate 10A, a bonding process for bonding the pair of substrates 10A and 10B to each other, and a slimming process for subjecting the pair of substrates 10A and 10B to slimming processing. That is, the method of producing the liquid crystal panel 10 according to the present embodiment is a so-called one drop fill method (ODF method). In the CF substrate production process among the processes, the spacer 12 is formed in addition to various types of structures being formed. That is, the CF substrate production process includes a spacer formation process.

In the seal section forming process, the seal section 11 is formed to be drawn in a frame shape using a dispenser device or the like for the outer peripheral end on an inner surface of the CF substrate 10A, as illustrated in FIG. 2A. In the liquid crystal dropping process, the seal section 11 is temporarily cured, and a liquid crystal material in a predetermined amount is then dropped onto the inner surface of the CF substrate 10A, as illustrated in FIG. 2B. In the subsequent bonding process, the paired substrates 10A and 10B are bonded to each other while the inner surface of the array substrate 10B opposes the inner surface of the CF substrate 10A on which the liquid crystal material is dropped under a vacuum environment, as illustrated in FIG. 2C. The liquid crystal material is expanded to have a uniform thickness between the pair of substrates 10A and 10B as the substrates are bonded to each other. When the seal section 11 is cured, the liquid crystal layer 10C sandwiched between the pair of substrates 10A and 10B is sealed. Then, in the slimming process, chemical polishing and slimming processing, for example, is preferably used, and the pair of substrates 10A and 10B is made thinner than the original plate thickness BT by supplying a solvent for dissolving a glass material, for example, to each of outer surfaces of the pair of substrates 10A and 10B and polishing the outer surfaces, as illustrated in FIG. 2D. More specifically, when the original plate thickness BT of the pair of substrates 10A and 10B is approximately 0.5 mm to 0.7 mm, for example, the plate thickness BT of the pair of substrates 10A and 10B is slimmed to approximately 0.1 mm to 0.3 mm by the substrates passing through the slimming process. The original shape of the pair of substrates 10A and 10B is illustrated with a two-dot and dash line in FIG. 2D.

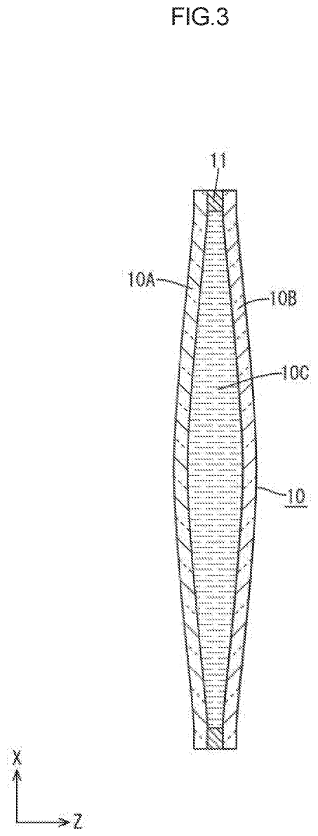

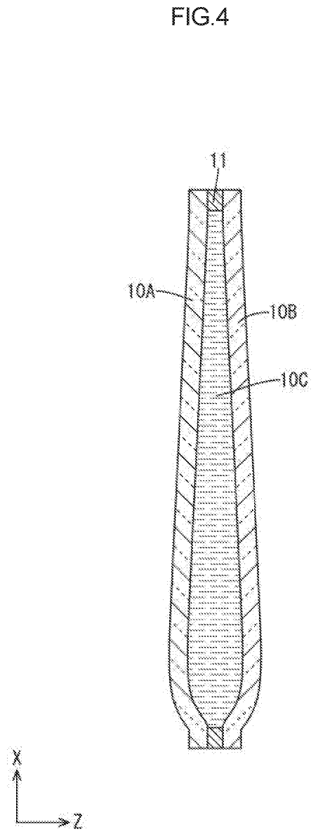

The above-described slimming process is useful when the liquid crystal panel 10 is thinned, but a production cost increases. Therefore, if reduction in the production cost is given priority over the thinning of the liquid crystal panel 10, the slimming process may not be performed. Thus, in recent years, when the liquid crystal panel 10 is produced, the slimming process may or may not be performed. Further, a target plate thickness BT may also tend to be diversified in the slimming process. When the plate thickness BT of the pair of substrates 10A and 10B constituting the liquid crystal panel 10 is diversified, the following problem may occur. That is, if the number of spacers 12 to be installed, for example, is made constant regardless of the plate thickness BT of the pair of substrates 10A and 10B being diversified, when the produced liquid crystal panel 10 is left in a leaned state for a predetermined time period such that its long side direction (X-axis direction) is along a vertical direction, the liquid crystal material may be accumulated on the lower end side of the liquid crystal panel 10 by gravity. More specifically, if the number of spacers 12 to be installed, for example, is constant and the plate thickness BT of the pair of substrates 10A and 10B is relatively small, the pair of substrates 10A and 10B is relatively easily deformed. Accordingly, when a filling amount of the liquid crystal material is rather excessive and when the liquid crystal material thermally expands under a high temperature environment, respective central portions in the long side direction of the pair of substrates 10A and 10B are deformed to expand, as illustrated in FIG. 3. Therefore, liquid crystal accumulation in which the liquid crystal material is accumulated on the lower end side of the liquid crystal panel 10 by gravity tends not to relatively easily occur. On the other hand, if the number of spacers 12 to be installed, for example, is constant and the plate thickness BT of the pair of substrates 10A and 10B is relatively large, the pair of substrates 10A and 10B is not relatively easily deformed. Accordingly, when the filling amount of the liquid crystal material is rather excessive and when the liquid crystal material thermally expands under a high temperature environment, the respective central portions in the long side direction of the pair of substrates 10A and 10B are not deformed much, as illustrated in FIG. 4. Therefore, liquid crystal accumulation tends to relatively easily occur. When the liquid crystal material is accumulated on the lower end side of the liquid crystal panel 10, the thickness of the liquid crystal layer 10C becomes locally large on the lower end side so that a display failure in which gradation display differs from its intention may occur.

As a result of earnest examination, the inventors of the present application have found that the above-described liquid crystal accumulation problem does not occur depending on only the plate thickness BT of the pair of substrates 10A and 10B but the distance D between the pair of substrates 10A and 10B and design of the spacer 12 that holds the distance D are associated therewith. A specific content of the examination will be described below.

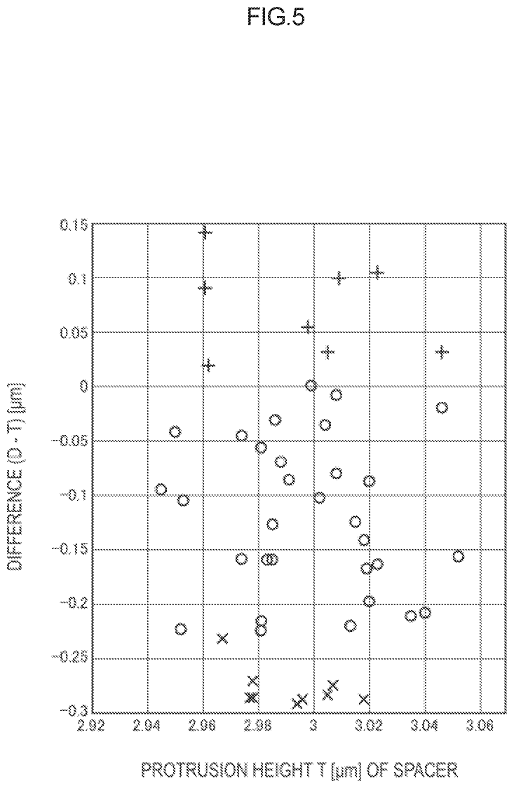

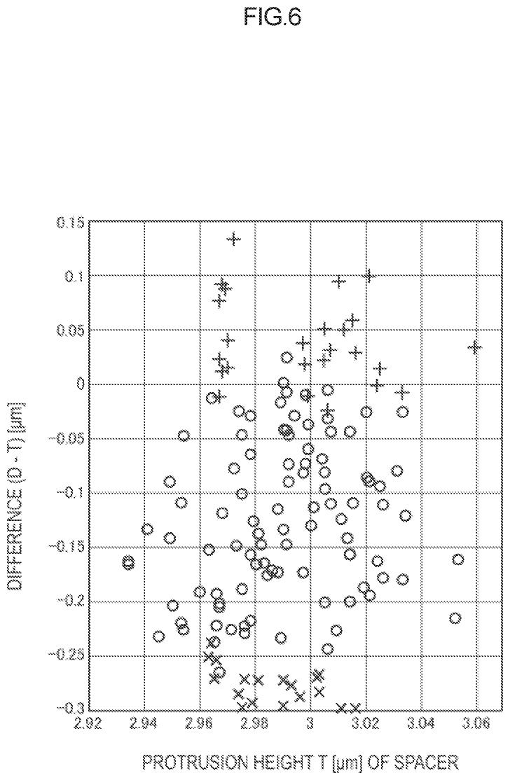

First, respective pluralities of two types of liquid crystal panels 10, which differ in a plate thickness BT of a pair of substrates 10A and 10B, for which a distance D between the pair of substrates 10A and 10B (a thickness of a liquid crystal layer 10C) and a protrusion height (height) T of a spacer 12 were changed, were produced, to perform a comparative experiment 1 for inspecting whether or not a failure occurs in each of the liquid crystal panels 10. The distance D between the pair of substrates 10A and 10B depends on a filling amount of a liquid crystal material composing the liquid crystal layer 10C. Inspection of the liquid crystal panel 10 in the experiment includes high-temperature inspection and low-temperature inspection, illustrated below. In the high-temperature inspection, an inspector visually observed the liquid crystal panel 10 via a polarizing plate for inspection after the liquid crystal panel 10 was left in a leaned state for 12 hours in a temperature environment of 85° C., to judge the presence or absence of unevenness. In the low-temperature inspection, the inspector visually observed the liquid crystal panel 10 via the polarizing plate for inspection after the liquid crystal panel 10 was left in a leaned state for 12 hours in a temperature environment of −40° C., to judge the presence or absence of a bubble. An experimental result of the experiment is as illustrated in FIG. 5 and FIG. 6. FIG. 5 illustrates an experimental result in a case where the plate thickness BT of the pair of substrates 10A and 10B is 0.15 mm, and FIG. 6 illustrates an experimental result in a case where the plate thickness BT of the pair of substrates 10A and 10B is 0.5 mm. In FIG. 5 and FIG. 6, a horizontal axis and a vertical axis respectively indicate a protrusion height T (a unit is “μm”) of the spacer 12 and a difference (D−T) (a unit is “μm”) obtained by subtracting the protrusion height T of the spacer 12 from the distance D between the pair of substrates 10A and 10B. In FIG. 5 and FIG. 6, a “∘” mark, a “+” mark, and a “x” mark respectively indicate an experimental result in which it is judged that there is neither unevenness nor a bubble, an experimental result in which it is judged that there is unevenness, and an experimental result in which there is a bubble.

The experimental result of the comparative experiment 1 will be described. Both FIG. 5 and FIG. 6 show that if a value of the difference (D−T) obtained by subtracting the protrusion height T of the spacer 12 from the distance D between the pair of substrates 10A and 10B is in a predetermined numerical range regardless of the protrusion height T of the spacer 12, it is judged that there is neither unevenness nor a bubble. More specifically, if the above-described value of the difference (D−T) is above a maximum value in the above-described numerical range, it is conceived that the liquid crystal material is accumulated on the lower end side of the liquid crystal panel 10 by gravity under a high-temperature environment because the filling amount of the liquid crystal material becomes excessive so that the distance D between the pair of substrates 10A and 10B becomes excessively larger than the protrusion height T of the spacer 12, and as a result, it is judged that there is unevenness. Conversely, if the above-described value of the difference (D−T) is below a minimum value in the above-described numerical range, it is conceived that the liquid crystal material thermally expands under a low-temperature environment because the filling amount of the liquid crystal material is insufficient so that the distance D between the pair of substrates 10A and 10B becomes excessively smaller than the protrusion height T of the spacer 12, and as a result, it is judged that there is a bubble. When the plate thickness BT of the pair of substrates 10A and 10B is 0.15 mm (when the plate thickness BT is small), a preferable numerical range of the difference (D−T) is −0.22 μm to −0.03 μm, and a range R between a minimum value and a maximum value in the numerical range (an absolute value of a difference between the minimum value and the maximum value) is 0.19 μm, as illustrated in FIG. 5. When the plate thickness BT of the pair of substrates 10A and 10B is 0.5 mm (when the plate thickness BT is large), a preferable numerical range of the difference (D−T) is −0.22 μm to 0 μm, and a range R between a minimum value and a maximum value in the numerical range is 0.22 μm, as illustrated in FIG. 6. Therefore, it can be said that the smaller the plate thickness BT of the pair of substrates 10A and 10B is, the wider the range R related to the above-described numerical range of the difference (D−T) tends to be. This is conceived to be because the pair of substrates 10A and 10B is easily deformed when the plate thickness BT of the pair of substrates 10A and 10B is small so that liquid crystal accumulation does not easily occur under the high-temperature environment even when the filling amount of the liquid crystal material becomes large. When the plate thickness BT of the pair of substrates 10A and 10B is either 0.15 mm or 0.5 mm, the maximum value in the preferable numerical range of the difference (D−T) is not a positive value. This shows that the protrusion height T of the spacer 12 is preferably in a relationship equal to or larger than the distance D between the pair of substrates 10A and 10B. The above-described experimental result shows that if the above-described difference (D−T) is appropriately set, neither the unevenness caused by the above-described liquid crystal accumulation nor the bubble caused by the above-described low temperature can easily occur, and further shows that the above-described difference (D−T) also affects the strength of the liquid crystal panel 10. The range R related to the numerical range of the above-described difference (D−T) is experimentally preferably in a numerical range of 0.13 μm to 0.17 μm regardless of the plate thickness BT of the pair of substrates 10A and 10B, and is further most preferably 0.15 μm as a central value in the numerical range when the effect is added to the range R. In the present embodiment, the range R “0.15 μm” related to the numerical range of the above-described difference (D−T) is set as a “reference value”.

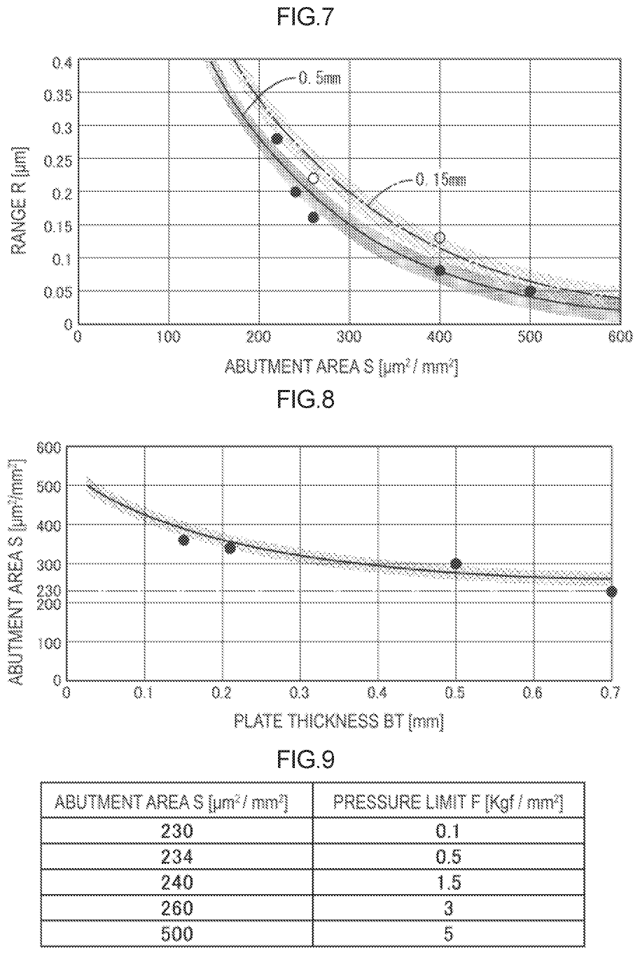

Then, respective pluralities of two types of liquid crystal panels 10, which differ in a plate thickness BT of a pair of substrates 10A and 10B, for which a difference (D−T) obtained by subtracting a protrusion height T of a spacer 12 from a distance D between the pair of substrates 10A and 10B and a substantial abutment area S per unit area of the spacer 12 on the array substrate 10B were changed, were produced, to perform a comparative example 2 for performing similar inspection to that in the above-described comparative experiment 1. In the comparative experiment 2, a range R related to a preferable numerical range of the difference (D−T) is obtained based on the inspection while a relationship between the range R and an upper-limit value of the above-described abutment area S related to the spacer 12 is plotted on a graph illustrated in FIG. 7. Among plots illustrated in FIG. 7, a “∘” mark is an experimental result in a case where the plate thickness BT of the pair of substrates 10A and 10B is 0.15 mm, and a “●” mark is an experimental result in a case where the plate thickness BT of the pair of substrates 10A and 10B is 0.5 mm. A curve illustrated in FIG. 7 is an approximate curve related to each of the above-described plots. The approximate curve illustrated in FIG. 7 is a function represented by “F=e^{(-a·x)}−b”. In the function, “x” is a value of the abutment area S related to the spacer 12, and “a” and “b” are respectively constants associated with the plate thickness BT of the pair of substrates 10A and 10B. In FIG. 7, an approximate curve in the case where the plate thickness BT is 0.15 mm and an approximate curve in the case where the plate thickness BT is 0.5 mm are respectively indicated by a one-dot and dash line and a solid line for distinction. In FIG. 7, a horizontal axis and a vertical axis respectively indicate a substantial abutment area S (a unit is “μm²/mm²”) per unit area of the spacer 12 on the array substrate 10B and a range R (a unit is “μm”) related to the preferable numerical range of the difference (D−T). The plots written on the graph of FIG. 7 is an upper-limit value of the abutment area S related to the spacer 12. If the abutment area S exceeds the upper-limit value even in the same range R, unevenness caused by liquid crystal accumulation may occur. The abutment area S related to the spacer 12 is calculated by multiplying the substantial unit abutment area on the array substrate 10B of each of a plurality of spacers 12 to be installed within a plate surface of the CF substrate 10A by the number of the spacers 12 to be installed per unit area on the plate surface of the CF substrate 10A. The above-described “unit abutment area” is a cross-sectional area obtained by cutting the spacer 12 parallel to its protruding distal end surface at a position lowered toward its protruding proximal end by a dimension of 0.1 μm from the protruding distal end surface, for example.

An experimental result of the comparative experiment 2 will be described. FIG. 7 shows that the range R related to the preferable numerical range of the difference (D−T) tends to be narrow when the abutment area S related to the spacer 12 becomes large while the above-described range R tends to be wide when the above-described abutment area S becomes small regardless of the plate thickness BT of the pair of substrates 10A and 10B. From this, if the above-described abutment area S is large, it is conceived that unevenness caused by liquid crystal accumulation easily occurs because the pair of substrates 10A and 10B is rigidly supported by the spacer 12 so that the pair of substrates 10A and 10B is not easily deformed, and as a result, the above-described range is narrowed. On the other hand, if the above-described abutment area S is small, it is conceived that unevenness caused by liquid crystal accumulation does not easily occur because easy deformation of the pair of substrates 10A and 10B to be supported by the spacer 12 is easily ensured, and as a result, the above-described range R is widened. Then, when a case where the plate thickness BT of the pair of substrates 10A and 10B is 0.15 mm (when the plate thickness BT is small) and a case where the plate thickness BT of the pair of substrates 10A and 10B is 0.5 mm (when the plate thickness BT is large) are compared with each other, it can be found that the range R in the case where the plate thickness BT is 0.15 mm tends to be wider than the range R in the case where the plate thickness BT is 0.5 mm when the abutment area S related to the spacer 12 is made the same. From this, it is conceived that unevenness caused by liquid crystal accumulation does not easily occur because the smaller the plate thickness BT of the pair of substrates 10A and 10B is, the more easily the pair of substrates 10A and 10B is deformed, and as a result, the above-described range R is widened. On the other hand, it is conceived that unevenness caused by liquid crystal accumulation easily occurs because the larger the plate thickness BT of the pair of substrates 10A and 10B is, the easily the pair of substrates 10A and 10B is not deformed, and as a result, the above-described range R is narrowed. FIG. 7 illustrates each of the approximate curves in a strip shape having a width of ±0.02 μm with respect to its central value (a solid line), and illustrates the strip-shaped approximate curves in respectively different shaded shapes. When each of the approximate curves is made to have the above-described width, a measurement error, a dimensional error of the liquid crystal panel 10, and the like can be permitted.

Then, for the graph (FIG. 7) described in the above-described comparative experiment 2, graphs were respectively created for cases where the plate thickness BT of the pair of substrates 10A and 10B is set to 0.21 mm and 0.7 mm, illustrations of which are omitted. Moreover, in the comparative experiment 3, an upper-limit value of the above-described abutment area S related to the spacer 12 in a case where the range R is set as a reference value (0.15 μm) is acquired for each of the plate thicknesses BT, and a graph on which data of the upper limit value is plotted is created, as illustrated in FIG. 8. A curve illustrated in FIG. 8 is an approximate curve related to each of the above-described plots. The approximate curve illustrated in FIG. 8 is a function represented by “F=K·e^{(-a·x)}+b”. In the function, “x” is a value of the plate thickness BT of the pair of substrates 10A and 10B, and “K”, “a”, and “b” are respectively constants. In FIG. 8, a horizontal axis and a vertical axis respectively indicate the plate thickness BT (a unit is “mm”) of the pair of substrates 10A and 10B and a substantial abutment area S per unit area (a unit is “μm²/mm²”) of the spacer 12 on the array substrate 10B.

An experimental result of the comparative experiment 3 will be described. FIG. 8 shows that the smaller the plate thickness BT of the pair of substrates 10A and 10B becomes, the larger the upper-limit value of the abutment area S related to the spacer 12 tends to be while the larger the plate thickness BT of the pair of substrates 10A and 10B becomes, the smaller the upper-limit value of the abutment area S related to the spacer 12 tends to be. From this, it is conceived that unevenness caused by liquid crystal accumulation does not easily occur because the smaller the plate thickness BT of the pair of substrates 10A and 10B is, the more easily the pair of substrates 10A and 10B is deformed depending on a variation in a filling amount of a liquid crystal material, and as a result the upper-limit value of the abutment area S related to the spacer 12 becomes large. On the other hand, it is conceived that unevenness caused by liquid crystal accumulation easily occurs because the larger the plate thickness BT of the pair of substrates 10A and 10B is, the less easily the pair of substrates 10A and 10B is deformed depending on the variation in the filling amount of the liquid crystal material, and as a result the upper-limit value of the abutment area S related to the spacer 12 becomes small. If the abutment area S related to the spacer 12 is made smaller than the above-described approximate curve regardless of the plate thickness BT of the pair of substrates 10A and 10B, the support of the pair of substrates 10A and 10B by the spacer 12 does not become excessive so that appropriate flexibility in which the pair of substrates 10A and 10B is deformed depending on the variation in the filling amount of the liquid crystal material is ensured. As a result, unevenness caused by liquid crystal accumulation does not easily occur. Since the range R is set as a reference value, a bubble caused by a low temperature does not easily occur. FIG. 8 illustrates the approximate curve in a strip shape having a width of ±20 μm²/mm² with respect to its central value (a solid line), and illustrates the strip-shaped approximate curve in a shaded shape. When the approximate curve is made to have the above-described width, a measurement error, a dimensional error of the liquid crystal panel 10, and the like can be permitted.

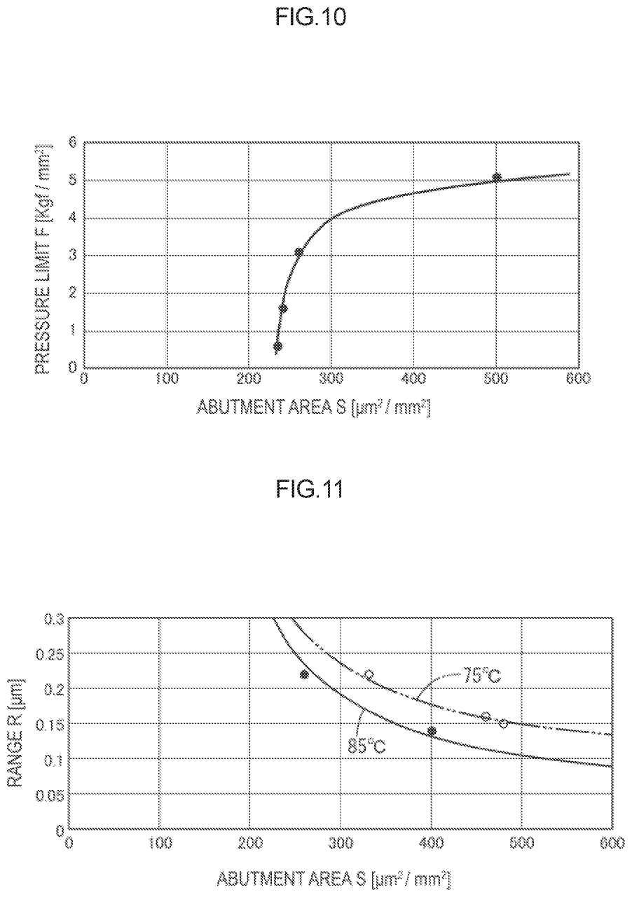

Then, a plurality of liquid crystal panels 10 that differ in the above-described abutment area S related to the spacer 12 were produced, to perform a comparative experiment 4 for applying pressure (an external force) from outside to the liquid crystal panels 10. In the comparative experiment 4, the pressure to be applied from outside to each of the liquid crystal panels 10 that differ in the abutment area S was gradually increased, and pressure immediately before leading to a state where a distance D between a pair of substrates 10A and 10B cannot be held because the spacer 12 included in each of the liquid crystal panels 10 is plastically deformed was measured as a pressure limit F. A result of the measurement is illustrated in FIG. 9 and FIG. 10. FIG. 9 is a table illustrating a substantial abutment area S (a unit is “μm²/mm²”) per unit area of the spacer 12 on the array substrate 10B and the pressure limit F (a unit is “Kgf/mm²”). FIG. 10 is a graph in which the substantial abutment area S per unit area of the spacer 12 on the array substrate 10B and the pressure limit F are respectively plotted on a horizontal axis and a vertical axis. An experimental result illustrated in FIG. 9 and FIG. 10 is substantially constant regardless of the plate thickness BT of the pair of substrates 10A and 10B.

The experimental result of the comparative experiment 4 will be described. FIG. 9 and FIG. 10 show that when the above-described abutment area S related to the spacer 12 is set to 230 μm²/mm², the pressure limit F is 0.1 Kgf/mm². The value “0.1 Kgf/mm²” corresponds to an assumed maximum value of a force produced when a user presses the liquid crystal panel 10 with his/her finger or the like when the produced liquid crystal panel 10 is used. Therefore, if the above-described abutment area S related to the spacer 12 is set to μm²/mm² or more, a situation where the spacer 12 is plastically deformed due to the pressure exerted from the finger or the like when the user uses the liquid crystal panel 10 can be avoided. Then, the above-described abutment area S related to the spacer 12 is set to 234 μm²/mm², the pressure limit F is 0.5 Kgf/mm². The value “0.5 Kgf/mm²” corresponds to an assumed maximum value of an external force to be exerted on the pair of substrates 10A and 10B from a production apparatus in processes for producing the liquid crystal panel 10. Therefore, if the above-described abutment area S related to the spacer 12 is set to 234 μm²/mm² or more, a situation where the spacer 12 is plastically deformed due to pressure to be exerted from the production apparatus on the pair of substrates 10A and 10B in the processes for producing the liquid crystal panel 10 can be avoided. Further, the above-described abutment area S related to the spacer 12 is set to 240 μm²/mm², the pressure limit F is 1.5 Kgf/mm². The value “1.5 Kgf/mm²” corresponds to three times of the assumed maximum value of the external force to be exerted on the pair of substrates 10A and 10B from the production apparatus in the processes for producing the liquid crystal panel 10. Therefore, if the above-described abutment area S related to the spacer 12 is 240 μm²/mm² or more, a reliability with which a situation where the spacer 12 is plastically deformed can be avoided even when unexpectedly large pressure is suddenly exerted from the production apparatus on the pair of substrates 10A and 10B in the processes for producing the liquid crystal panel 10 becomes high.

Based on examination of the comparative experiment 1 to the comparative experiment 4 described above, an abutment area determination process for determining the substantial abutment area S per unit area of the spacer 12 on the array substrate 10B depending on the plate thickness BT of the pair of substrates 10A and 10B is performed prior to a spacer formation process included in a CF substrate production process in the method of producing the liquid crystal panel 10. In the abutment area determination process, the abutment area S is determined, within a range sandwiched between an approximate curve obtained by plotting, when the difference (D−T) between the protrusion height T of the spacer 12 and the distance D between the pair of substrates 10A and 10B is set as a reference value, an upper-limit value of the abutment area S for each of the plate thicknesses BT and a straight line on which the abutment area S is set to 230 μm²/mm² regardless of the plate thickness BT, depending on the plate thickness BT, as illustrated in FIG. 8. The approximate curve is obtained by the above-described comparative experiment 3, and the straight line is obtained by the above-described comparative experiment 4. In FIG. 8, the straight line is indicated by a one-dot and dash line. When the above-described abutment area S related to the spacer 12 is determined to be within the above-described range in the abutment area determination process, all the above-described liquid crystal accumulation problem, the above-described low temperature bubble problem, and a problem that the spacer 12 is plastically deformed due to pressing with a user's finger or the like can be made difficult to create even if the plate thickness BT of the pair of substrates 10A and 10B constituting the liquid crystal panel 10 to be produced has any value. In the approximate curve, the smaller the plate thickness BT of the pair of substrates 10A and 10B becomes, the larger the upper-limit value of the above-described abutment area S related to the spacer 12 tends to be while the larger the plate thickness BT of the pair of substrates 10A and 10B becomes, the smaller the upper-limit value of the above-described abutment area S related to the spacer 12 tends to be. Therefore, in the abutment area determination process, when the plate thickness BT of the pair of substrates 10A and 10B is small, the abutment area S related to the spacer 12 can be determined to be larger than when the plate thickness BT of the pair of substrates 10A and 10B is large. After the abutment area determination process is performed, the spacer 12 is formed on the CF substrate 10A to have the abutment area S determined in the abutment area determination process in the spacer formation process included in the CF substrate production process. In the bonding process then performed, the CF substrate 10A including the spacer 12 formed to have the abutment area S determined in the abutment area determination process and the array substrate 10B are bonded to each other, to produce the liquid crystal panel 10.

More specifically, in the abutment area determination process according to the present embodiment, a minimum value and a maximum value related to the difference (D−T) between the protrusion height T of the spacer 12 and the distance D between the pair of substrates 10A and 10B are found based on the comparative experiment 1, and a range R between the minimum value and the maximum value is set as a reference value. The difference (D−T) between the distance D between the pair of substrates 10A and 10B and the protrusion height T of the spacer 12 is preferably set to a value between a maximum value at which the above-described liquid crystal accumulation problem can be solved and a minimum value at which the above-described low-temperature bubble problem can be solved. In the abutment area determination process, the range R between the minimum value and the maximum value related to the above-described difference (D−T) is set as the reference value. Accordingly, both the above-described liquid crystal accumulation problem and the above-described low-temperature bubble problem are made difficult to create. In the abutment area determination process according to the present embodiment, the reference value is set in a range from 0.13 μm to 0.17 μm, and the reference value is set to 0.15 μm from within the range. Thus, both the above-described liquid crystal accumulation problem and the above-described low-temperature bubble problem are made more difficult to create.

In the abutment area determination process according to the present embodiment, the abutment area S is preferably determined depending on the plate thickness BT of the pair of substrates 10A and 10B within the range sandwiched between the above-described approximate curve and the straight line on which the abutment area S is set to 234 μm²/mm² regardless of the plate thickness BT. Thus, the spacer 12 is not easily plastically deformed due to the external force to be exerted on the pair of substrates 10A and 10B from the production apparatus or the like in the production processes, which is favorable in improving yield. Further, in the abutment area determination process, the abutment area S is more preferably determined depending on the plate thickness BT of the pair of substrates 10A and 10B within the range sandwiched between the above-described approximate curve and the straight line on which the abutment area S is set to 240 μm²/m² regardless of the plate thickness BT. Thus, even when an unexpectedly large outer force is suddenly exerted on the pair of substrates 10A and 10B from the production apparatus or the like in the production processes, a reliability with which the plastic deformation of the spacer 12 is prevented becomes high, which is more favorable in improving yield.

As described above, the method of producing the liquid crystal panel 10 according to the present embodiment includes an abutment area determination process for determining, within a range sandwiched between an approximate curve obtained by plotting, when a difference (D−T) between a protrusion height (height) T of a spacer 12 that is interposed between a pair of substrates 10A and 10B with a liquid crystal layer 10C interposed therebetween and holds a distance D between the pair of substrates 10A and 10B by abutting on the array substrate 10B as its counterpart and the distance D is set as a reference value, an upper-limit value of a substantial abutment area S per unit area on the array substrate 10B as the counterpart for each of a plurality of plate thicknesses BT of the pair of substrates 10A and 10B that differ from one another and a straight line on which the abutment area S is set to 230 μm²/mm² regardless of the plate thickness BT, the abutment area S depending on the plate thickness BT, a spacer formation process for forming the spacer 12 to have the abutment area S determined in the abutment area determination process, and a bonding process for bonding the pair of substrates 10A and 10B to each other.

First, the spacer 12 formed to be interposed between the pair of substrates 10A and 10B with the liquid crystal layer 10C sandwiched therebetween is made to abut on the array substrate 10B as the counterpart, to hold the distance D between the pair of substrates 10A and 10B, i.e., the thickness of the liquid crystal layer 10C. The distance D between the pair of substrates 10A and 10B can vary depending on a filling amount of a liquid crystal material composing the liquid crystal layer 10C. When the filling amount of the liquid crystal material becomes excessive and the above-described distance D becomes excessively larger than the protrusion height T of the spacer 12, the liquid crystal material is accumulated on the lower end side of the produced liquid crystal panel 10 by gravity when the liquid crystal panel 10 is leaned so that a display failure may occur. Conversely, when the filling amount of the liquid crystal material is insufficient and the above-described distance D becomes excessively smaller than the protrusion height T of the spacer 12, a bubble may occur due to the liquid crystal material thermally contracting under a low-temperature environment. On the other hand, if the difference (D−T) between the distance D between the pair of substrates 10A and 10B and the protrusion height T of the spacer 12 is appropriately set, both the above-described liquid crystal accumulation problem and the above-described low-temperature bubble problem can be made difficult to create. A value of the difference (D−T) is the above-described “reference value”.

On the other hand, the substantial abutment area S per unit area on the array substrate 10B as the counterpart of the spacer 12 is calculated, when the spacer 12 includes a plurality of spaces 12 to be installed, for example, by multiplying the substantial unit abutment area on the array substrate 10B as a counterpart of each of the spacers 12 by the number of the spacers 12 to be installed per unit area. When the abutment area S related to the spacer 12 becomes excessively large, the pair of substrates 10A and 10B is rigidly supported by the spacer 12 so that the pair of substrates 10A and 10B is not easily deformed. Accordingly, the above-described liquid crystal accumulation problem may occur. Conversely, if the above-described abutment area S related to the spacer 12 becomes excessively small, there may occur a problem that the spacer 12 cannot resist an external force when the external force is exerted on the produced liquid crystal panel 10 but is plastically deformed. Further, the larger the plate thickness BT of the pair of substrates 10A and 10B is, the less easily the pair of substrates 10A and 10B is deformed depending on a variation in the filling amount of the liquid crystal material composing the liquid crystal layer 10C. Accordingly, the liquid crystal accumulation problem tends to easily occur. Therefore, an appropriate value of the above-described abutment area S related to the spacer 12 can vary depending on the plate thickness BT of the pair of substrates 10A and 10B.

In view of these circumstances, in producing the liquid crystal panel 10, the abutment area determination process for determining the abutment area S related to the spacer 12 depending on the plate thickness BT of the pair of substrates 10A and 10B is performed prior to the spacer formation processing being performed. More specifically, in the abutment area determination process, the approximate curve is obtained by setting the reference value related to the difference (D−T) between the protrusion height T of the spacer 12 and the distance D between the pair of substrates 10A and 10B and plotting the upper-limit value of the above-described abutment area S related to the spacer 12 in the reference value for each of the plurality of plate thicknesses BT. The approximate curve suggests a tendency that the smaller the plate thickness BT of the pair of substrates 10A and 10B becomes, the larger the upper-limit value of the above-described abutment area S related to the spacer 12 tends to be while the larger the plate thickness BT of the pair of substrates 10A and 10B becomes, the smaller the upper-limit value of the above-described abutment area S related to the spacer 12 tends to be. This is conceived to reflect that the liquid crystal accumulation problem does not easily occur even if the above-described abutment area S related to the spacer 12 is large to some degree because the substrates 10A and 10B are easily deformed depending on a variation in the filling amount of the liquid crystal material composing the liquid crystal layer 10C if the plate thickness BT of the pair of substrates 10A and 10B is small. Conversely, this is conceived to reflect a situation where the liquid crystal accumulation problem occurs unless the above-described abutment area S related to the spacer 12 is made sufficiently small because the substrates 10A and 10B are not easily deformed depending on the variation in the filling amount of the liquid crystal material composing the liquid crystal layer 10C if the plate thickness BT of the pair of substrates 10A and 10B is large.

In the abutment area determination process, the above-described abutment area S related to the spacer 12 is determined depending on the plate thickness BT of the pair of substrates 10A and 10B within the range sandwiched between the above-described approximate curve and the straight line on which the abutment area S related to the spacer 12 is set to 230 μm²/mm² regardless of the plate thickness BT of the pair of substrates 10A and 10B. When the above-described abutment area S related to the spacer 12 is set to 230 μm²/mm² or more regardless of the plate thickness BT of the pair of substrates 10A and 10B, a situation where the spacer 12 is plastically deformed can be avoided even if the external force to be exerted on the produced liquid crystal panel 10 reaches 0.1 Kgf/mm². The value “0.1 Kgf/mm²” corresponds to an assumed maximum value of a force produced when a user presses the liquid crystal panel 10 with his/her finger, for example, when the produced liquid crystal panel 10 is used. Therefore, when the above-described abutment area S related to the spacer 12 is determined to be within the above-described range, all the above-described liquid crystal accumulation problem, the above-described low temperature bubble problem, and the problem that the spacer 12 is plastically deformed can be made difficult to create even if the plate thickness BT of the pair of substrates 10A and 10B constituting the liquid crystal panel 10 to be produced has any value. Then, in the spacer formation process, the spacer 12 is formed to have the abutment area S determined in the abutment area determination process. In the bonding process, when the CF substrate 10A and the array substrate 10B are bonded to each other, the liquid crystal panel 10 in which the spacer 12 formed to have the abutment area S determined in the abutment area determination process is interposed therebetween.

In the abutment area determination process, the minimum value and the maximum value related to the difference (D−T) are found, and the range R between the minimum value and the maximum value is set as the reference value. The difference (D−T) between the distance D between the pair of substrates 10A and 10B and the protrusion height T of the spacer 12 is preferably set to a value between a maximum value at which the above-described liquid crystal accumulation problem can be solved and a minimum value at which the above-described low-temperature bubble problem can be solved. In the abutment area determination process, the range R between the minimum value and the maximum value related to the above-described difference (D−T) is set as the reference value. Accordingly, both the above-described liquid crystal accumulation problem and the above-described low-temperature bubble problem are made difficult to create.

In the abutment area determination process, the reference value is set in a range from 0.13 μm to 0.17 μm. Thus, both the above-described liquid crystal accumulation problem and the above-described low-temperature bubble problem are made more difficult to create.

In the abutment area determination process, the reference value is set to 0.15 μm. Thus, both the above-described liquid crystal accumulation problem and the above-described low-temperature bubble problem are made much more difficult to create.

In the abutment area determination process, the abutment area S is determined depending on the plate thickness BT within the range sandwiched between the approximate curve and the straight line on which the abutment area S is set to 234 μm²/mm² regardless of the plate thickness BT. As a result, the situation where the spacer 12 is plastically deformed can be avoided even if the external force to be exerted on the produced liquid crystal panel 10 reaches 1.5 Kgf/mm². The value “0.5 Kgf/mm²” corresponds to the assumed maximum value of the external force to be exerted on the pair of substrates 10A and 10B from the production apparatus or the like in the processes for producing the liquid crystal panel 10. Therefore, when the above-described abutment area S related to the spacer 12 is determined to be within the above-described range, the spacer 12 is not easily plastically deformed due to the external force to be exerted on the pair of substrates 10A and 10B from the production apparatus or the like in the production processes, which is favorable in improving yield.

In the abutment area determination process, the abutment area S is determined depending on the plate thickness BT within the range sandwiched between the approximate curve and the straight line on which the abutment area S is set to 240 μm²/mm² regardless of the plate thickness BT. As a result, the situation where the spacer 12 is plastically deformed can be avoided even if the external force to be exerted on the produced liquid crystal panel 10 reaches 1.5 Kgf/mm². The value “1.5 Kgf/mm²” corresponds to three times the assumed maximum value of the external force to be exerted on the pair of substrates 10A and 10B from the production apparatus or the like in the processes for producing the liquid crystal panel 10. Therefore, when the above-described abutment area S related to the spacer 12 is determined to be within the above-described range, a reliability with which the spacer 12 is prevented from being plastically deformed becomes high even if the unexpectedly large external force has been suddenly exerted on the pair of substrates 10A and 10B from the production apparatus or the like in the production processes, which is more favorable in improving yield.

In the abutment area determination process, the approximate curve is set in a strip shape having a width of +20 μm²/mm². The width of ±20 μm²/mm² with respect to a central value in the strip-shaped approximate curve is an error that can occur in the upper-limit value of the abutment area S to be plotted for each of the plate thicknesses BT of the pair of substrates 10A and 10B, and the more appropriate abutment area S can be determined based on the approximate curve considering the error.

The method of producing the liquid crystal panel 10 includes a slimming process for polishing a plate surface opposite to a plate surface on the side of the liquid crystal layer 10C in the pair of substrates 10A and 10B and slimming the pair of substrates 10A and 10B. As a result, in the slimming process, the pair of substrates 10A and 10B is slimmed to have a predetermined plate thickness BT. When the pair of substrates 10A and 10B is slimmed, the plate thickness BT of the pair of substrates 10A and 10B becomes diverse. Accordingly, the above-described liquid crystal accumulation problem or the like easily occurs depending on the filling amount of the liquid crystal material. In this respect, in the abutment area determination process, the abutment area S related to the spacer 12 within the range between the approximate curve and the straight line is determined depending on the plate thickness BT to be a purpose in the slimming process. Accordingly, even if the plate thickness BT of the pair of substrates 10A and 10B is diverse, the above-described liquid crystal accumulation problem or the like can be made difficult to create.

The spacer 12 is selectively formed on the CF substrate (the one substrate) 10A in the pair of substrates 10A and 10B in the spacer formation process, and the spacer 12 is made to abut on the array substrate (the other substrate) 10B when the paired substrates 10A and 10B are bonded to each other in the bonding process. As a result, the area of the protruding distal end surface of the spacer 12 matches the substantial unit abutment area of the spacer 12 on the array substrate 10B. Therefore, the substantial abutment area S per unit area on the array substrate 10B can be easily calculated.

### Second Embodiment

A second embodiment of the present invention will be described with reference to FIG. 11 to FIG. 14. In the second embodiment, a changed abutment area determination process is illustrated. An overlapping description is omitted for a similar structure, function, and effect to those in the above-described first embodiment.

In the abutment area determination process according to the present embodiment, a plurality of approximate curves are prepared for each of a plurality of maximum environmental temperatures MT assumed in a use environment of a liquid crystal panel, and an abutment area S is determined depending on the maximum environmental temperature MT in addition to a plate thickness BT within a range sandwiched between the one approximate curve selected from among the plurality of approximate curves and a straight line. The liquid crystal panel also varies in the maximum environmental temperature MT to be assumed when used in different environments. For example, the maximum environment temperature MT to be assumed in an in-vehicle liquid crystal panel tends to be higher than the maximum environmental temperature MT to be assumed in an in-room stationary liquid crystal panel. The liquid crystal panels which differ in the maximum environmental temperature MT to be thus assumed differ in a thermal expansion amount of a liquid crystal material composing a liquid crystal layer, for example. Accordingly, the liquid crystal panels may also differ in an upper-limit value of an abutment area S related to a spacer due to the difference. Examination performed for an effect of the maximum environmental temperature MT will be described below.

First, respective pluralities of two types of liquid crystal panels, which differ in a maximum environmental temperature MT, for which a difference (D−T) obtained by subtracting a protrusion height T of a spacer from a distance D between a pair of substrates and a substantial abutment area S per unit area of the spacer on an array substrate were changed, were produced, to perform a comparative experiment 5 for performing similar inspection to that in the above-described comparative experiment 1 described in the first embodiment. In the comparative experiment 5, a range R related to a preferable numerical range of the difference (D−T) is obtained based on the inspection while a relationship between the range R and an upper-limit value of the above-described abutment area S related to the spacer is plotted on a graph illustrated in FIG. 11. In the comparative experiment 5, the plate thickness BT of the pair of substrates is set to 0.15 mm. Among plots illustrated in FIG. 11, a “∘” mark is an experimental result in a case where the maximum environmental temperature MT is 75° C., and a “●” mark is an experimental result in a case where the maximum environmental temperature MT is 85° C. Therefore, the experimental result in the case where the maximum environmental temperature MT is 85° C. is the same as the experimental result in the case where the plate thickness BT of the pair of substrates is set to 0.15 mm in the above-described comparative experiment 2 in the first embodiment. A curve illustrated in FIG. 11 is an approximate curve associated with each of the above-described plots. In FIG. 11, an approximate curve in the case where the maximum environmental temperature MT is 75° C. and an approximate curve in the case where the maximum environmental temperature MT is 85° C. are respectively indicated by a one-dot and dash line and a solid line for distinction. In FIG. 11, a horizontal axis and a vertical axis respectively indicate the substantial abutment area S per unit area (a unit area is “μm²/mm²”) of the spacer on the array substrate and the range R (a unit is “μm”) related to the preferable numerical range of the difference (D−T). The plot written in the graph of FIG. 11 is the upper-limit value of the abutment area S related to the spacer. If the abutment area S exceeds the upper-limit value even in the same range R, unevenness caused by liquid crystal accumulation may occur.

An experimental result of the comparative experiment 5 will be described. FIG. 11 shows that the larger the abutment area S related to the spacer becomes, the narrower the range R related to the preferable numerical range of the difference (D−T) tends to be while the smaller the above-described abutment area S becomes, the wider the above-described range R tends to be regardless of the maximum environmental temperature MT. The reason for this is as described in the above-described comparative experiment 2 in the first embodiment. When a case where the maximum environmental temperature MT is 75° C. (a relatively low temperature) and a case where the maximum environmental temperature MT is 85° C. (a relatively high temperature) are compared with each other, it is found that the range R in the case where the maximum environmental temperature MT is 75° C. tends to be wider than that in the case where the maximum environmental temperature MT is 85° C. From this, it is conceived that a situation where a liquid crystal material is accumulated on the lower end side of the liquid crystal panel by gravity (liquid crystal accumulation) does not easily occur, and unevenness caused by the liquid crystal accumulation does not easily occur even if the liquid crystal panel is left in a leaned state because the lower the maximum environmental temperature MT is, the lower the viscosity of the liquid crystal material is, and as a result the above-described range R is widened. On the other hand, it is conceived that the liquid crystal accumulation easily occurs, and unevenness caused by the liquid crystal accumulation easily occurs if the liquid crystal panel is left in a leaned state because the higher the maximum environmental temperature MT is, the higher the viscosity of the liquid crystal material is, and as a result the above-described range R is narrowed. The lower the maximum environmental temperature MT is, the smaller the thermal expansion amount of the liquid crystal material is. Conversely, the higher the maximum environmental temperature MT is, the larger the thermal expansion amount of the liquid crystal material becomes. Accordingly, this is conceived to also affect a result that the lower the maximum environmental temperature MT is, the wider the range R becomes while the higher the maximum environmental temperature MT is, the narrower the range R becomes. In all the above-described comparative experiment 1 to comparative experiment 4 described in the first embodiment, the maximum environmental temperatures MT is set to 85° C., which is supplementary.

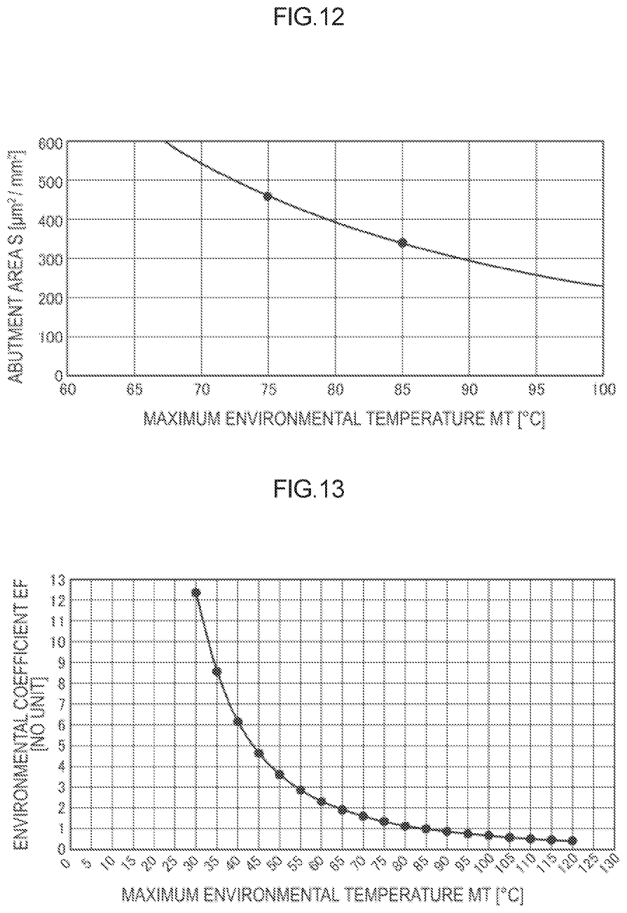

Then, in a comparative experiment 6, a graph on which an upper-limit value of the above-described abutment area S related to the spacer in a case where the range R is set as a reference value (0.15 μm) in the graph (FIG. 11) described in the above-described comparative experiment 5 is acquired for each of maximum environmental temperatures MT and data of the upper limit value is plotted was created, as illustrated in FIG. 12. A curve illustrated in FIG. 12 is an approximate curve related to each of the above-described plots. In FIG. 12, a horizontal axis and a vertical axis respectively indicate the plurality of maximum environmental temperatures MT (a unit is “° C.”) to be assumed in a use environment of a liquid crystal panel and a substantial abutment area S per unit area (a unit is “μm²/mm²”) of the spacer on an array substrate. In the comparative experiment 6, a plate thickness BT of a pair of substrates is set to 0.15 mm, like in the comparative experiment 5.

An experimental result of the comparative experiment 6 will be described. FIG. 12 shows that the lower the maximum environmental temperature MT becomes, the larger the upper-limit value of the abutment area S related to the spacer tends to be while the higher the maximum environmental temperature MT becomes, the smaller the upper-limit value of the abutment area S related to the spacer tends to be. From this, it is conceived that liquid crystal accumulation does not easily occur, and unevenness caused by the liquid crystal accumulation does not easily occur even if the liquid crystal panel is left in a leaned state because the lower the maximum environmental temperature MT is, the lower the viscosity of the liquid crystal material is, and as a result the upper-limit value of the abutment area S related to the spacer increases. On the other hand, it is conceived that liquid crystal accumulation easily occurs, and unevenness caused by the liquid crystal accumulation easily occurs if the liquid crystal panel is left in a leaned state because the higher the maximum environmental temperature MT is, the higher the viscosity of the liquid crystal material is, and as a result the upper-limit value of the abutment area S related to the spacer decreases.

Then, for the above-described comparative experiment 6, a value of the abutment area S related to the spacer is acquired for each 5° C. until the maximum environmental temperature MT reaches 120° C. from 30° C. Moreover, in a comparative experiment 7, a relationship between a maximum environmental temperature MT and an environmental coefficient EF of an abutment area S related to a spacer with a case where the maximum environmental temperature MT is 85° C. as a reference is plotted on a graph illustrated in FIG. 13. The environmental coefficient EF of the abutment area S related to the spacer is a proportionality coefficient in which an upper-limit value of the abutment area S related to the spacer in the case where the maximum environmental temperature MT is 85° C. is set to “1”. Therefore, this means that the upper-limit value of the abutment area S related to the spacer is smaller than when the maximum environmental temperature MT is 85° C. if the environmental coefficient EF is smaller than one while the upper-limit value of the abutment area S related to the spacer is larger than when the maximum environmental temperature MT is 85° C. if the environmental coefficient EF is larger than one. In FIG. 13, a horizontal axis and a vertical axis respectively indicate a maximum environmental temperatures MT (a unit is “° C.”) and an environmental coefficient EF (no unit) of the abutment area S related to the spacer. An experimental result of the comparative experiment 7 will be described. According to FIG. 13, it can be said that the higher the maximum environmental temperature MT becomes, the more the environmental coefficient EF of the abutment area S related to the spacer tends to decrease and the smaller a change amount of the environmental coefficient EF tends to be while the lower the maximum environmental temperature MT becomes, the more the environmental coefficient EF of the abutment area S related to the spacer tends to increase and the larger the change amount of the environmental coefficient EF tends to be. Particularly, if the maximum environmental temperature MT is 65° C., the environmental coefficient EF of the abutment area S related to the spacer is approximately two, and the upper-limit value of the abutment area S related to the spacer is two times as high as that when the maximum environmental temperature MT is 85° C. as the reference. Thus, in a use environment in which the maximum environmental temperature MT is low, the upper-limit value of the abutment area S related to the spacer can be made high. Accordingly, even if pressure exerted on the liquid crystal panel becomes high, the liquid crystal panel is not easily damaged, which is favorable in improving a shock resistance.

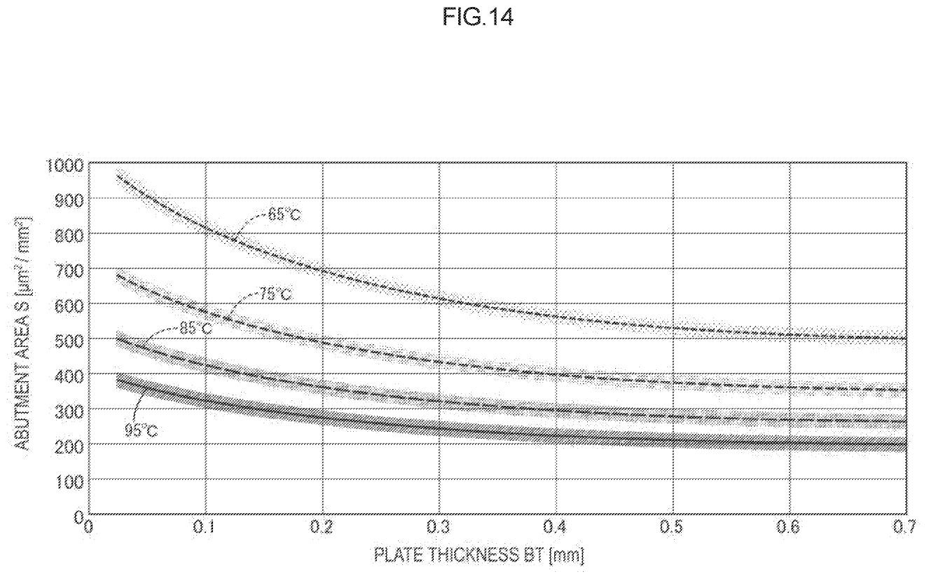

Then, in a comparative experiment 8, a plurality of approximate curves that differ in a maximum environmental temperature MT were acquired by multiplying the numerical value of the abutment area S related to the approximate curve illustrated in FIG. 8 as the experimental result of the above-described comparative experiment 3 in the first embodiment by the numerical value of the environmental coefficient EF as the experimental result of the above-described comparative experiment 7. More specifically, the experimental result of the above-described comparative experiment 3 in the first embodiment indicates a relationship between the plate thickness BT and the abutment area S in the case where the maximum environmental temperature MT is 85° C. Accordingly, if among the environmental coefficients EF obtained from the above-described comparative experiment 7, the environmental coefficient EF that matches the maximum environmental temperature MT of interest is selected, and the numerical value of the abutment area S related to the approximate curve illustrated in FIG. 8 is multiplied by a numerical value of the environmental coefficient EF, an approximate curve in the maximum environmental temperature MT of interest is obtained. More specifically, in the comparative experiment 8, respective approximate curves in a case where the maximum environmental temperature MT is 65° C., a case where the maximum environmental temperature is 75° C., and a case where the maximum environmental temperature MT is 95° C. are acquired, and the approximate curves, together with an approximate curve in the case where the maximum environmental temperature MT is 85° C., are illustrated in FIG. 14. In FIG. 14, the approximate curve in the case where the maximum environmental temperature MT is 65° C., the approximate curve in the case where the maximum environmental temperature MT is 75° C., the approximate curve in the case where the maximum environmental temperature MT is 85° C., and the approximate curve in the case where the maximum environmental temperature MT is 95° C. are respectively indicated by a finest broken line, a moderately fine broken line, a coarsest broken line, and a solid line for distinction. In FIG. 14, a horizontal axis and a vertical axis respectively indicate a plate thickness (a unit is “mm”) of the pair of substrates, and a substantial abutment area S per unit area (a unit is “μm²/mm²”) of the spacer on the array substrate. In FIG. 14, a straight line on which the abutment area S is set to 230 μm²/mm² regardless of the plate thickness BT is indicated by a one-dot and dash line.

An experimental result of the comparative experiment 8 will be described. According to FIG. 14, it can be said that the upper-limit value of the abutment area S related to the spacer tends to be higher when the maximum environmental temperature MT is low than when the maximum environmental temperature MT is high. It is noted that an amount of increase of the upper-limit value of the abutment area S related to the spacer with a decrease in the plate thickness BT of the pair of substrates is larger when the maximum environmental temperature MT is low than when the maximum environmental temperature MT is high. Therefore, in a use environment in which the maximum environmental temperature MT is low and if the plate thickness BT of the pair of substrates is made small, the upper-limit value of the abutment area S related to the spacer can be made high. Accordingly, even if pressure exerted on the liquid crystal panel becomes high, the liquid crystal panel is not more easily damaged, which is favorable in further improving a shock resistance. FIG. 14 illustrates each of the approximate curves in a strip shape having a width of ±20 μm²/mm² with respect to its central value (a solid line or a broken line), and illustrates the strip-shaped approximate curve in a shaded shape. When the approximate curve is made to have the above-described width, a measurement error, a dimensional error of the liquid crystal panel, and the like can be permitted.

Based on examination of the comparative experiment 1 to the comparative experiment 4 described above, in the abutment area determination process according to the present embodiment, a plurality of approximate curves are prepared for each of a plurality of maximum environmental temperatures MT to be assumed in a use environment of a liquid crystal panel, and an abutment area S is determined depending on the maximum environmental temperature MT in addition to a plate thickness BT within a range sandwiched between the one approximate curve selected from among the plurality of approximate curves and a straight line, as illustrated in FIG. 14. As a result, if the maximum environmental temperature MT is high, an upper-limit value within the above-described range is kept low. Accordingly, when a spacer is formed in a spacer formation process based on the abutment area S determined in the abutment area determination process, a liquid crystal accumulation problem can be made more reliably difficult to create.

As described above, according to the present embodiment, in the abutment area determination process, the plurality of approximate curves are prepared for each of the plurality of maximum environmental temperatures MT to be assumed in the use temperature of the liquid crystal panel, and the abutment area S is determined depending on the maximum environmental temperature MT in addition to the plate thickness BT within the range sandwiched between the one approximate curve selected from among the plurality of approximate curves and the straight line. The liquid crystal material composing the liquid crystal layer has a property that its viscosity changes depending on an environmental temperature, and the above-described liquid crystal accumulation problem may easily occur particularly when the viscosity decreases under the high-temperature environment. Therefore, the upper-limit value of the above-described abutment area S related to the spacer needs to be made lower when the maximum environmental temperature MT to be assumed in the use environment of the liquid crystal panel is high than when the maximum environmental temperature MT is low. In view of these circumstances, in the abutment area determination process, a plurality of approximate curves, described above, are prepared for each of the plurality of maximum environmental temperatures MT to be assumed in the use environment of the liquid crystal panel, the one approximate curve is selected from among the plurality of approximate curves depending on the maximum environmental temperature of interest, and the above-described abutment area S associated with the spacer is determined depending on the plate thickness BT of the pair of substrates within the range sandwiched between the selected approximate curve and the above-described straight line. As a result, if the maximum environmental temperature MT is high, the upper-limit value within the above-described range is kept low. Accordingly, when the spacer is formed in the spacer formation process based on the abutment area S determined in the abutment area determination process, the liquid crystal accumulation problem can be made more reliably difficult to create.

### Third Embodiment

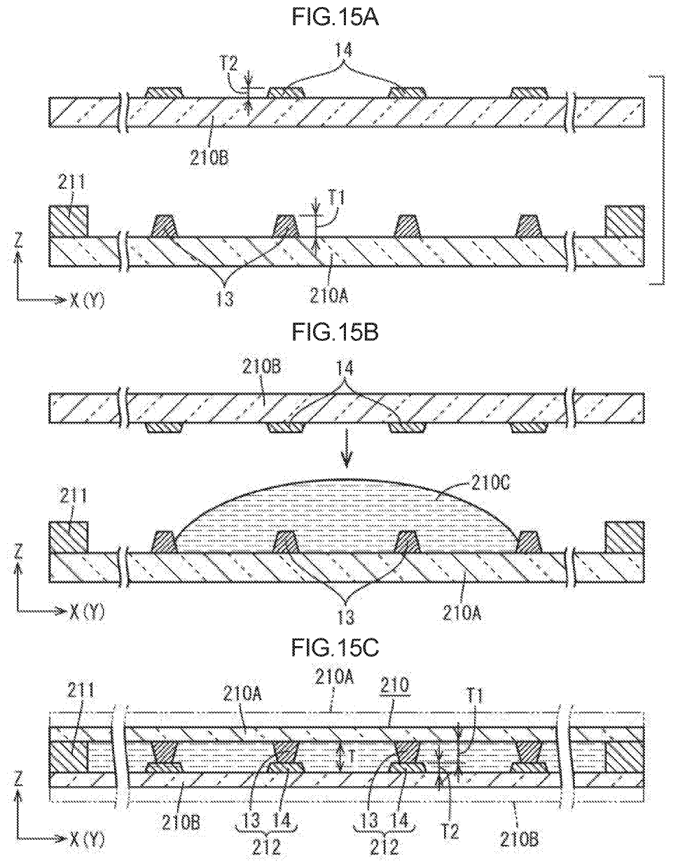

A third embodiment of the present invention will be described with reference to FIG. 15A to FIG. 15C. In the third embodiment, a changed space formation process and bonding process are illustrated. Overlapping description is omitted for a similar structure, function, and effect to those in the above-described first embodiment.

An outline of a method of producing a liquid crystal panel 210 according to the present embodiment will be described with respect to FIG. 15A to FIG. 15C. The method of producing the liquid crystal panel 210 includes at least a CF substrate production process for forming various types of structures including a first spacer constituent section 13 on a CF substrate 210A, an array substrate production process for forming various types of structures including a second spacer constituent section 14 on an array substrate 210B, a seal section formation process for forming a seal section 211 on the CF substrate 210A (see FIG. 15A), a liquid crystal dropping process for dropping a liquid crystal material on the CF substrate 210A, a bonding process for bonding the pair of substrates 210A and 210B to each other, and a slimming process for subjecting the pair of substrates 210A and 210B to slimming processing (see FIG. 15C). The present embodiment differs from the above-described first embodiment in that a spacer 212 includes a first spacer constituent section 13 formed on the CF substrate 210A and a second constituent section 14 formed on the array substrate 210B. Therefore, it can be said that the CF substrate production process and the array substrate production process respectively include spacer formation processes. The seal section formation process, the liquid crystal dropping process, and the slimming process are similar to those in the above-described first embodiment.

In the spacer formation process included in the CF substrate production process, a plurality of first spacer constituent sections 13 are formed in a predetermined distribution within a plane of the CF substrate 210A, as illustrated in FIG. 15A. A protrusion height T1 of the first spacer constituent section 13 is lower than a protrusion height T of the spacer 212. In the spacer formation process included in the array substrate production process, a plurality of second spacer constituent sections 14 are formed in a predetermined distribution within a plane of the array substrate 210B. A protrusion height T2 of the second spacer constituent section 14 is lower than a protrusion height T of the spacer 212, and a difference therebetween is substantially equal to the protrusion height T1 of the first spacer constituent section 13. A plurality of second spacer constituent sections 14 are disposed at a position overlapping the plurality of first spacer constituent sections 13 in a planar view. Therefore, when the paired substrates 210A and 210B are bonded to each other in the bonding process, a protruding distal end surface of the first spacer constituent section 13 and a protruding distal end surface of the second spacer constituent section 14 are made to abut on each other, as illustrated in FIGS. 15B and 15C. The first spacer constituent section 13 and the second spacer constituent section 14, which abut on each other, constitute the spacer 212. An abutment area of both the respective protruding distal end surfaces of the first spacer constituent section 13 and the second spacer constituent section 14 matches a substantial unit abutment area of the spacer 212. As a result, an abutment area S related to the spacer 212 is calculated by multiplying the abutment area of both the protruding distal end surfaces of the first spacer constituent section 13 and the second spacer constituent section 14 by the number of spacers 212 to be installed per unit area on respective plate surfaces of the pair of substrates 210A and 210B.

In the method of producing the liquid crystal panel 210 according to the present embodiment, the first spacer constituent section 13 constituting the spacer 212 is formed on the CF substrate (the one substrate) 210A in the pair of substrates 10A and 10B while the second spacer constituent section 14 constituting the spacer 212 is formed on the array substrate (the other substrate) 210B in the spacer formation process, and the first spacer constituent section 13 and the second spacer constituent section 14 are made to abut on each other when the paired substrates 210A and 210B are bonded to each other in the bonding process. As a result, the abutment area of both the respective protruding distal end surfaces of the first spacer constituent section 13 and the second spacer constituent section 14 matches the substantial unit abutment area of the spacer 212 on the array substrate 210B.

### Other Embodiments

The present invention is not limited to the embodiments described by the above-described description and drawings, and embodiments, described below, for example, are included in the technical scope of the present invention.

(1) Although the experimental result of each of the above-described comparative experiments 2 and 3 in the first embodiment illustrates an example of an approximate curve and its function, a specific approximate curve and its function can change depending on various conditions such as a maximum environmental temperature, and are not limited to contents illustrated in the above-described experimental result.

(2) Although in each of the above-described embodiments, a case where the reference value in the range is set to 0.15 μm is illustrated, the reference value in the range can be approximately changed to numerical values other than 0.15 μm. Even in the case, although the reference value in the range is preferably selected from within a range of 0.13 μm to 0.17 μm, the present invention is not necessarily limited to this.

(3) Although a case where a lower-limit value in the range as the reference in determining the abutment area related to the spacer in the abutment area determination process is set to 230 μm²/mm², 234 μm²/mm², or 240 μm²/mm² has been illustrated in each of the above-described embodiments, a specific numerical value of the above-described lower-limit value can also be set to values other than the numerical values as long as it is larger than 230 μm²/mm².

(4) Although in the above-described second embodiment, a case where the four approximate curves that differ in the maximum environmental temperature are prepared has been illustrated, three or less approximate curves that differ in a maximum environmental temperature can also be prepared, or five or more approximate curves that differ in a maximum environmental temperature can also be prepared. A specific numerical value of the maximum environmental temperature can also be appropriately changed.

(5) Although in each of the above-described embodiments, a case where the spacer is formed on the CF substrate has been illustrated, the spacer may be formed on the array substrate. In the case, the array substrate production process includes the spacer formation process.

(6) In addition to the above-described item (5), the spacer may be formed on each of the CF substrate and the array substrate. In the case, the first spacer constituent section formed on the CF substrate and the second spacer constituent section formed on the array substrate are preferably arranged to abut on each other as both the substrates are bonded to each other. At this time, the sum of the protrusion height of the first spacer constituent section and the protrusion height of the second spacer constituent section is a protrusion height of the spacer. In the case, the CF substrate production process and the array substrate production process respectively include spacer formation processes.

(7) Although in each of the above-described embodiments, a case where the one drop fill method is used has been illustrated, a vacuum injection method may be used. In the case, a liquid crystal filling process is added instead of the liquid crystal dropping process after the bonding process.

(8) Although in each of the above-described embodiments, a case where the chemical polishing and slimming processing is performed in the slimming process has been illustrated, slimming processing in a method other than the chemical polishing and slimming processing may be used.

(9) Although in each of the above-described embodiments, a case where the liquid crystal panel having the rectangular shape is disposed such that its long side direction and its short side direction respectively match the X-axis direction and the Y-axis direction in each of the drawings has been illustrated, the liquid crystal panel can also be disposed such that its long side direction and its short side direction respectively match the Y-axis direction and the X-axis direction in each of the drawings. In this case, an axis line in a vertical direction in FIG. 3 and FIG. 4 is a Y-axis. That is, liquid crystal accumulation may occur on the lower end side in the Y-axis direction of the liquid crystal panel. When the liquid crystal panel is leaned such that its short side direction is along a vertical direction, a liquid crystal accumulation problem may occur to some degree or another.

1. A method of producing a liquid crystal panel, the method comprising:
an abutment area determination step for determining, within a range sandwiched between an approximate curve obtained by plotting, when a difference between a height of a spacer that is interposed between a pair of substrates with a liquid crystal layer sandwiched therebetween and holds a distance between the pair of substrates by abutting on its counterpart and the distance is used as a reference value, an upper-limit value of a substantial abutment area per unit area on the counterpart for each of a plurality of plate thicknesses of the pair of substrates that differ from one another and a straight line on which the abutment area is set to 230 μm²/mm² regardless of the plate thickness, the abutment area depending on the plate thickness;
a spacer formation step for forming the spacer to have the abutment area determined in the abutment area determination step; and
a bonding step for bonding the pair of substrates to each other.

2. The method of producing the liquid crystal panel according to claim 1, wherein in the abutment area determination step, a minimum value and a maximum value related to the difference are found, and a range between the minimum value and the maximum value is set as the reference value.

3. The method of producing the liquid crystal panel according to claim 2, wherein in the abutment area determination step, the reference value is set in a range from 0.13 μm to 0.17 μm.

4. The method of producing the liquid crystal panel according to claim 3, wherein in the abutment area determination step, the reference value is set to 0.15 μm.

5. The method of producing the liquid crystal panel according to claim 1, wherein in the abutment area determination step, the abutment area is determined depending on the plate thickness within a range sandwiched between the approximate curve and a straight line on which the abutment area is set to 234 μm²/mm² regardless of the plate thickness.

6. The method of producing the liquid crystal panel according to claim 5, wherein in the abutment area determination step, the abutment area is determined depending on the plate thickness within a range sandwiched between the approximate curve and a straight line on which the abutment area is set to 240 μm²/mm regardless of the plate thickness.

7. The method of producing the liquid crystal panel according to claim 1, wherein in the abutment area determination step, the approximate curve is set in a strip shape having a width of ±20 μm²/mm².

8. The method of producing the liquid crystal panel according to claim 1, wherein in the abutment area determination step, the approximate curve includes a plurality of approximate curves prepared for each of a plurality of maximum environmental temperatures assumed in a use environment of the liquid crystal panel, and the abutment area is determined depending on the maximum environmental temperature in addition to the plate thickness within a range sandwiched between the one approximate curve selected from among the plurality of approximate curves and the straight line.

9. The method of producing the liquid crystal panel according to claim 1, further comprising a slimming step for polishing a plate surface opposite to a plate surface on the side of the liquid crystal layer in the pair of substrates to slim the pair of substrates.

10. The method of producing the liquid crystal panel according to claim 1, wherein
the spacer is selectively formed on one of the pair of substrates in the spacer formation step, and
the spacer is made to abut on the other substrate when the paired substrates are bonded to each other in the bonding step.

11. The method of producing the liquid crystal panel according to claim 1, wherein
a first spacer constituent section constituting the spacer is formed on one of the pair of substrates while a second spacer constituent section constituting the spacer is formed on the other substrate in the spacer formation step, and
the first spacer constituent section and the second spacer constituent section are made to abut on each other when the paired substrates are bonded to each other in the bonding step.
